(19) United States
(12) Patent Application Publication
(10) Pub. No.: US 2026/0058523 A1
(43) Pub. Date: Feb. 26, 2026

(54) METHOD FOR PRODUCING HYDROELECTRIC POWER GENERATOR AND HYDROELECTRIC POWER GENERATOR

(71) Applicants: Akira SAITO, Kanagawa (JP); Hirokazu MIYAKE, Shizuoka (JP); Goro KATSUYAMA, Kanagawa (JP)

(72) Inventors: Akira SAITO, Kanagawa (JP); Hirokazu MIYAKE, Shizuoka (JP); Goro KATSUYAMA, Kanagawa (JP)

(21) Appl. No.: 19/108,174

(22) PCT Filed: Sep. 28, 2023
(86) PCT No.: PCT/JP2023/035508

§ 371 Date: Mar. 3, 2025

(30) Foreign Application Priority Data
Sep. 30, 2022 (JP) 2022-157366
Oct. 3, 2022 (JP) 2022-159470

(51) Int. Cl. H02K 7/18; F03B 7/00

(52) U.S. Cl. CPC H02K 7/1823; F03B 7/00; F05B 2220/706

(57) ABSTRACT

To provide a method for producing a hydroelectric power generator. The method enables easy assembly and can promptly and easily perform replacement of parts, repair, and maintenance at a site of use, such as countries with emerging economies. A method for producing a hydroelectric power generator includes modeling a part having a shape corresponding to a shape of an electric generator using a 3D printer, and assembling a hydroelectric power generator with the part having the shape corresponding to the shape of the electric generator.

### TECHNICAL FIELD

The present disclosure relates to a method for producing a hydroelectric power generator, and a hydroelectric power generator.

### BACKGROUND ART

In recent years, pico-hydroelectric power generation or micro-hydroelectric power generation with an output of 100 KW or less has been widely used in Europe and countries with emerging economies, such as some countries in Asia, in view of the environmental friendliness and active use of renewable energy. However, low-maintenance or low-cost pico-hydroelectric power generation or micro-hydroelectric power generation has not been realized yet.

As a compact hydroelectric power generator installed in a water channel of a relatively low flow rate, such as an agricultural irrigation channel, for example, the following hydroelectric power generator has been proposed. That is, the hydroelectric power generator that contains a cylindrical water intake drum, where a central axis of the water intake drum is vertically aligned to allow water to fall downwards inside the cylindrical water intake drum, a guide member disposed at the inner side of the water intake drum and configured to guide the water to a certain direction, a rotatable screw disposed downstream of the guide member, where the rotatable screw rotates as the water fed by the guide member is received, and an electric power generator coupled to a shaft of the rotatable screw (see, for example, PTL 1). However, the proposed hydroelectric power generator is not satisfactory in terms of easiness of assembly, easiness of repair, maintenance, costs, etc.

A large number of irrigation channels including agricultural irrigation channels exist in various countries. Sizes and flow rates of irrigation channels vary. Pico-hydroelectric power generation or micro-hydroelectric power generation for use in such irrigation channels has an advantage that it is not necessary to significantly modify an irrigation channel for use. If the existing irrigation channel is used as it is, however, a rotating assembly or blade structures for the pico-hydroelectric power generator or micro-hydroelectric power generator may be damaged or broken down due to foreign matter (e.g., twigs, driftwood pieces, and fallen leaves) that flows in. In order to shorten a period of interruption at the time of breakdown, therefore, it is desired that assembly of the hydroelectric power generator, replacement of the parts, and repair of the hydroelectric power generator can be promptly carried out at a site of use. Considering the above-described need, for example, hub dynamos are suitably used because an electric generator can be constituted at a low cost by utilizing a readily available hub dynamo, which is generally used for lighting of bicycles, for the electric generator of the hydroelectric power generator.

### CITATION LIST

### Patent Literature

PTL 1: Japanese Unexamined Patent Application Publication (JP-A) No. 2009-221882

### SUMMARY OF INVENTION

### Technical Problem

However, shapes, sizes, and types of hub dynamos vary. Therefore, it is difficult to promptly acquire parts for coupling to hub dynamos, which hinders further expansion of pico-hydroelectric power generation or micro-hydroelectric power generation.

The present disclosure aims to provide a method for producing a hydroelectric power generator, where the method enables easy assembly and can promptly and easily perform replacement of parts, repair, and maintenance at a site of use, such as countries with emerging economies.

### Solution to Problem

The means for solving the above-described problem is as follows. A method for producing a hydroelectric power generator according to the present disclosure includes modeling a part having a shape corresponding to a shape of an electric generator using a 3D printer, and assembling a hydroelectric power generator with the part having the shape corresponding to the shape of the electric generator.

### Advantageous Effects of Invention

The present disclosure can provide a method for producing a hydroelectric power generator, where the method enables easy assembly and can promptly and easily perform replacement of parts, repair, and maintenance at a site of use, such as countries with emerging economies.

### BRIEF DESCRIPTION OF DRAWINGS

FIG. 1 is a perspective view illustrating an example of a hydroelectric power generator produced by the method for producing a hydroelectric power generator of the present disclosure.

FIG. 2 is a perspective view illustrating a side view of the example of the hydroelectric power generator.

FIG. 3 is an exploded perspective view illustrating the example of the hydroelectric power generator.

FIG. 4 is a perspective view illustrating an example of an electric generator of the hydroelectric power generator.

FIG. 5 is a perspective view illustrating an example of a coupling member of the hydroelectric power generator.

FIG. 6 is a perspective view illustrating an example of the hydroelectric power generator according to the first embodiment.

FIG. 7A is a perspective view illustrating an example of a blade structure of the hydroelectric power generator according to the first embodiment.

FIG. 7B is a perspective view illustrating another example of the blade structure of the hydroelectric power generator according to the first embodiment.

FIG. 7C is a perspective view illustrating yet another example of the blade structure of the hydroelectric power generator according to the first embodiment.

FIG. 7D is a perspective view illustrating yet another example of the blade structure of the hydroelectric power generator according to the first embodiment.

FIG. 8 is a partial cross-sectional view illustrating a state where the blade structure is disposed between the base A and the base B.

FIG. 9 is a perspective view illustrating an example of the electric generator.

FIG. 10 is a perspective view illustrating an example of the hydroelectric power generator according to the first comparative embodiment.

FIG. 11A is a perspective view illustrating an example of the blade structure of the hydroelectric power generator according to the first comparative embodiment.

FIG. 11B is a perspective view illustrating another example of the blade structure of the hydroelectric power generator according to the first comparative embodiment.

FIG. 11C is a perspective view illustrating yet another example of the blade structure of the hydroelectric power generator according to the first comparative embodiment.

FIG. 11D is a perspective view illustrating yet another example of the blade structure of the hydroelectric power generator according to the first comparative embodiment.

FIG. 12 is a perspective view illustrating an example of the hydroelectric power generator according to the second comparative embodiment.

FIG. 13A is a perspective view illustrating an example of the blade structure of the hydroelectric power generator according to the second comparative embodiment.

FIG. 13B is a perspective view illustrating another example of the blade structure of the hydroelectric power generator according to the second comparative embodiment.

FIG. 13C is a perspective view illustrating yet another example of the blade structure of the hydroelectric power generator according to the second comparative embodiment.

FIG. 13D is a perspective view illustrating yet another example of the blade structure of the hydroelectric power generator according to the second comparative embodiment.

FIG. 14(a) to (c) of FIG. 14 are views illustrating the evaluation results of the torque of the hydroelectric power generator according to the first embodiment in which the blade structure of FIG. 7A is mounted.

FIG. 15(a) to (c) of FIG. 15 are views illustrating the evaluation results of the torque of the hydroelectric power generator according to the first embodiment in which the blade structure of FIG. 7B is mounted.

FIG. 16(a) to (c) of FIG. 16 are views illustrating the evaluation results of the torque of the hydroelectric power generator according to the first embodiment in which the blade structure of FIG. 7C is mounted.

FIG. 17(a) to (c) of FIG. 17 are views illustrating the evaluation results of the torque of the hydroelectric power generator according to the first embodiment in which the blade structure of FIG. 7D is mounted.

### DESCRIPTION OF EMBODIMENTS

### (Method of Producing Hydroelectric Power Generator)

The method for producing a hydroelectric power generator according to the present disclosure includes a modeling step and an assembling step, preferably further includes a model-data generation step, and may further include other steps, as necessary.

According to the method for producing the hydroelectric power generator of the present disclosure, a hydroelectric power generator can be easily assembled at a site of use, and replacement of parts, repair, and maintenance can be promptly and easily carried out at a site of use, such as countries with emerging economies, because the method includes modeling a part having a shape corresponding to a shape of an electric generator using a 3D printer, and assembling a hydroelectric power generator with the part having the shape corresponding to the shape of the electric generator. For example, the shape, size, and type of a hub dynamo used as an electric generator significantly vary, and a part for coupling to the hub dynamo needs to be produced to suit the particular shape, size, and type of the individual hub dynamo used. According to the present disclosure, the part can be produced promptly at a low cost using a 3D printer. Moreover, the number of parts constituting the hydroelectric power generator is small, thus the hydroelectric power generator can be easily assembled at a site of use by fixing with screws.

### <Hydroelectric Power Generator>

A hydroelectric power generator produced by the method for producing the hydroelectric power generator according to the present disclosure includes, for example, a rotatable shaft, a first base and second base, blade structures (vanes), and an electric generator. The hydroelectric power generator may further include other members, as necessary. The first base and second base are rotatable together with the rotatable shaft, where the rotatable shaft is disposed to pass through the first base and second base, and the first base and second base are disposed to face each other. As the blade structures receive water pressure, the blade structures rotate the first base and second base together with the rotatable shaft that sits at a center of rotation. The electric generator is configured to generate electricity as the rotatable shaft rotates. An assembly of the first base, the second base, and the blade structures may be referred to as a rotating assembly hereinafter.

### —Rotatable Shaft—

The shape, size, and material of the rotatable shaft are not particularly limited, and may be appropriately selected according to the intended purpose.

Examples of the material of the rotatable shaft include metals and resins.

The metals are not particularly limited, and may be appropriately selected according to the intended purpose. Examples of the metals include stainless steel, iron, aluminum, titanium, nickel alloys, carbon steel, chromium steel, and manganese steel.

The resins are not particularly limited, and may be appropriately selected according to the intended purpose. Examples of the resins include polyether ether ketone (PEEK) resins, Teflon (registered trademark), MC nylon resins, ultra-high-molecular-weight polyethylene resins, polyacetal resins, polystyrene resins, styrene-acrylonitrile copolymers, styrene-butadiene copolymers, styrene-maleic anhydride copolymers, polyester resins, polyvinyl chloride resins, vinyl chloride-vinyl acetate copolymers, polyvinyl acetate resins, polyvinylidene chloride resins, polyacrylate resins, phenoxy resins, polycarbonate resins, polyvinyl butyral resins, polyvinyl formal resins, polyvinyl toluene resins, poly-N-vinylcarbazole, acrylic resins, silicone resins, epoxy resins, melamine resins, urethane resins, phenol resins, and alkyd resins. The above-listed examples may be used alone or in combination.

### —First Base and Second Base—

The first base and second base are members that are rotatable together with the rotatable shaft, where the rotatable shaft is passed through and the first base and second base are disposed to face each other. Shapes, sizes, materials, and structures of the first base and second base are not particularly limited, and may be appropriately selected according to the intended purpose.

Examples of the material of the first base and the material of the second base include metals and resins. Examples of the metals and the resins include the metals and the resins listed as the material of the rotatable shaft.

Among the above-listed examples, a resin is preferred in view of a reduction in weight of the base, and a recycled plastic material or a bioplastic material, or both is preferred in view of a reduction in environmental loads.

Examples of the shape of the first base and the shape of the second base include disk shapes.

The size of the first base and the size of the second base may be appropriately selected according to the size of the hydroelectric power generator.

The structure of the first base and the structure of the second base may be each a single-layer structure or a multiple-layer structure.

The first base has first holes corresponding to the first coupling holes of the blade structures. The second base has second holes corresponding to the second coupling holes of the blade structures.

The first base and second base each have fourth coupling holes for coupling to the coupling member.

### —Blade Structures—

The blade structures (vanes) are members that rotate the first base and the second base together with the rotatable shaft that sits at a center of rotation, as the blade structures receive water pressure. Shapes, sizes, and materials of the blade structures are not particularly limited, and may be appropriately selected according to the intended purpose.

Examples of the material of each blade structure include metals and resins. Examples of the metals and the resins include the metals and the resins listed as the material of the rotatable shaft.

Among the above-listed examples, a resin is preferred in view of a reduction in weight of the blade structure, and a recycled plastic material or a bioplastic material, or both is preferred in view of a reduction in environmental loads.

Examples of the shapes of the blade structures include box shapes capable of retaining water.

The sizes of the blade structures may be appropriately selected according to the size of the hydroelectric power generator.

The structures of the blade structures may be each a single-layer structure or a multiple-layer structure.

The blade structures each have a plurality of first coupling holes and second coupling holes for coupling the blade structures between the first base and the second base.

### —Rotating Assembly—

A rotating assembly is a unit where the first base, the second base, and the blade structure are assembled.

The material of the rotating assembly preferably includes a recycled plastic material or a bioplastic material, or both. Since a recycled plastic material or a bioplastic material, or both is used, the weight of the rotating assembly can be reduced, use of the abovementioned material contributes to a reduction in generation of CO₂, and environmental loads can be reduced. Particularly when a recycled plastic material is used, a material can be acquired at a place of use through commonly practiced recycling, thus, availability of the material is improved. Therefore, use of the recycled plastic material is preferred. The material is more preferably a material for 3D printers produced by a three-dimensional (3D) production device, because the effort of installing a production facility for the rotating assembly can be reduced.

As described later as the first embodiment, the hydroelectric power generator preferably includes a base A as the first base, a base B as the second base, and one or more blade structures. The base A has a recess A at a surface of the base A. The base B has a recess B at a surface of the base B. The blade structure has a projection a and a projection b, where the projection a is rotatably inserted into the recess A and the projection b is rotatably inserted into the recess B.

### —Recycled Plastic Material—

The recycled plastic material is a plastic material produced by recycling plastics that have been used once then discarded. The history of the recycled plastics is the oldest among environmentally friendly plastics. Many products have been already produced from recycled plastics. There are mainly two technologies for producing recycled plastics, “material recycling” and “chemical recycling.”

The material recycling is a technology for using the used plastic, as it is, as a raw material to produce a new product. For example, used PET bottles are separated and collected, followed by being sorted. Then, processes (e.g., pulverization, washing, and removal of foreign matter) are performed to yield recycled plastics, called flakes or pellets. Using the resulting recycled plastics, different plastic products, such as trays and films, are formed. Alternatively, the recycled plastics are formed into fiber filaments to produce fabrics. However, the recycled plastics have disadvantages, such that the recycled plastic material produced by the material recycling tends to have a lower quality compared to a new plastic product, and use of the recycled plastics is limited.

The chemical recycling is a technology where used plastics are chemically decomposed to return back to a petroleum raw material or monomers to produce a plastic raw material having a similar quality to a new product. The chemical recycling is more recent technology compared to the material recycling, and has excellent characteristics that recycling can be performed even when different types of plastics are mixed together, or foreign matter or contaminants are contained. As the technology of chemical recycling has been developed, a “bottle to bottle” production for producing PET bottles from the used PET bottles can be realized.

The recycled plastic material is not particularly limited, and may be appropriately selected according to the intended purpose. Examples of the recycled plastic material include polyethylene (PE), polypropylene (PP), ethylene-propylene copolymers, polybutadiene, acrylonitrile-butadiene-styrene copolymers (ABS), polystyrene (PS), acrylonitrile-chlorinated polyethylene-styrene copolymer resins (ACS), acrylonitrile-styrene copolymer resins (AS), polybutene resins, alkyd resins, amino resins, acrylonitrile-acrylic rubber-styrene copolymer resins (ASA), bismaleimide triazine resins, chlorinated polyether, chlorinated polyethylene, acrylic resins, epoxy resins, ethylene-alpha-olefin copolymers, ethylene-vinyl acetate-vinyl chloride copolymers, ethylene-vinyl chloride copolymer, ethylene vinyl alcohol resins (EVA), ionomers, methacrylstyrene copolymers, nitrile resins, polyester [e.g., polyethylene terephthalate (PET), polybutylene terephthalate (PBT), etc.], olefin vinyl alcohol copolymers, petroleum resins, phenol resins, polyacetal, polyacrylate, polyamide, polyarylsulfone, polybenzimidazole, polybutylene, polycarbonate, polyether ether ketone, polyether ketone, polyether nitrile, polyether sulfone, polyketone, methacrylic resins, polymethyl pentene, polyphenylene ether, polyphenylene sulfide, polysulfone, butadiene-styrene resins, polyurethane, polyvinyl acetal, polyvinyl alcohol, polyvinyl chloride, polyvinylidene chloride, silicone resins, polyvinyl acetate, xylene resins, crosslinked polyolefin (e.g., crosslinked polyethylene, etc.), crosslinked polystyrene, unsaturated polyester resins, urea resins, melamine resins, fluororesins, biodegradable resins, thermoplastic elastomers, and ethylene-propylene-diene copolymers (EPDM).

### —Bioplastics—

The bioplastics are the collective name for plastics produced using biomass as a raw material (biomass plastics) and plastics having biodegradability (biodegradable plastic). However, biomass-derived materials do not necessarily have biodegradability. Conversely, biodegradable materials are not necessarily derived from biomass.

### —Biomass Plastics—

The biomass plastics are plastics formed using a biological resource (biomass), which is a renewable resource, as a raw material. Synthesis methods for the biomass plastics are roughly classified into two. In the first method, corn or sugarcane-derived starch or sugar is used as a raw material. The starch or sugar is then transformed into a different substance, for example, by fermentation to synthesize a monomer, and the monomer is polymerized to produce a polymer that is a bioplastic. Examples of the polymer produced by the above-described method include polylactic acid (PLA) that is a polymer of lactic acid, and polyhydroxyalkanoate (PHA) produced by bacteria. In the second method, polysaccharide (e.g., cellulose) is extracted from plants, the extracted polysaccharide is derived to impart thermal plasticity, utilizing a structure of the polymer skeleton of the extracted polysaccharide, to thereby produce a biomass plastic (e.g., cellulose acetate).

Polymers produced using biomass as a raw material (mainly cellulose derivatives, such as nitrocellulose) had been widely researched before synthesis of polymers derived from fossil resources was started. Since the first half of the 20th century, however, high performance polymers derived from fossil resources (e.g., nylon, polypropylene, etc.) have been produced at low costs with high volume. Therefore, the research on the polymers produced using biomass has subsided. Since the second half of the 20th century, materials produced using biomass as a raw material have been again noted due to increasing social awareness on the environmental issues.

### —Biodegradable Plastics—

The biodegradable plastics are plastics that can be used in the same manner as general plastics. After use, the biodegradable plastics are ultimately decomposed into water and carbon dioxide by bacteria existing in nature.

As the biodegradable plastics, there are biodegradable plastics derived from biological resources (biomass) (biomass plastics) and biodegradable plastics derived from petroleum (petroleum-based synthetic plastics). Raw materials of the biodegradable plastics are not limited, except that the biodegradable plastics have biodegradability. The mainstream of the biodegradable plastics is biomass plastics using biological resources (biomass) as a raw material, many of which use starch or sugar as a raw material. However, not all of the plastics using biomass as a raw material have biodegradability. For example, bio PET and bio PE are formed using biomass as a raw material, but do not have biodegradability.

Examples of the plastics using biomass as a raw material, as a major biodegradable plastic, include polylactic acid, polycaprolactone, polyhydroxyalkanoate (PHA, bacterial polyester), polyglycol acid, modified polyvinyl alcohol, casein, modified starch, and polysaccharide derivatives of low substitution degrees (e.g., cellulose acetate of low substitution degree). Examples of the petroleum-derived biodegradable plastics include PET copolymers.

### —Electric Generator—

The electric generator is not particularly limited, except that the electric generator can generate electricity as the rotatable shaft is rotated. The electric generator may be appropriately selected electric generators available in the related art according to the intended purpose. The electric generator may be an AC electric generator or a DC electric generator. Examples of the electric generator include rotating magnetic field AC electric generators, DC electric generators with commutators, and magnetic drive pumps.

The rotating magnetic field AC electric generators are not particularly limited. Examples of the rotating magnetic field AC electric generators include hub dynamos used for lighting of bicycles. The hub dynamo includes a cylindrical housing portion and a rotatable shaft, where two or more magnets are fixed on the inner circumferential surface of the housing portion to form a coil portion. The hub dynamo is designed to generate electricity by electromagnetic induction with the coil portion, as result of the rotations of the housing portion including the magnets. Since the hub dynamo is inexpensive, use of the hub dynamo is suitable in countries with emerging economies.

The magnetic drive pump includes a driven magnet disposed inside a rotor, and a drive magnet magnetically bonded to the driven magnet. Along with the rotating motions of the drive magnet, the driven magnet is synchronously rotated to suction pump a fluid. A rotating magnet (drive magnet) can be rotated in conjunction with rotations of the rotor due to magnetic force, where the rotating magnet and the rotator are arranged to be apart from each other so that the fluid cannot pass. Since the magnetic drive pump does not use a mechanical seal (shaft seal device), corrosion or soiling of the pump does not occur even after a long period of use, and leakage of water, which may be caused by deterioration of the mechanical seal, does not occur. Therefore, use of the magnetic drive pump is advantageous.

### —Other Members—

Other members are not particularly limited, and may be appropriately selected according to the intended purpose. Examples of other members include a power storage unit, and a foreign matter separation unit.

The power storage unit is a unit configured to store generated electricity. The power storage unit may be capable of transmitting generated electricity. The power storage unit is preferably detachably mounted on the hydroelectric power generator. Since the hydroelectric power generator can store the generated electricity as well as transmitting the generated electricity, the hydroelectric power generator can be used easily in a simple manner, and the generated electricity can be used by the hydroelectric power generator itself.

### <Modeling Step>

The modeling step is a step that includes modeling a part having a shape corresponding to a shape of an electric generator using a 3D printer.

The part having the shape corresponding to the shape of the electric generator is preferably a coupling member for coupling a rotating assembly to the electric generator, where the rotating assembly is rotatably coupled to a rotatable shaft. Since the coupling member is disposed, the hub dynamo serving as the electric generator and the rotating assembly can be stably and securely coupled and fixed together.

Shape, sizes, and types of hub dynamo used as the electric generator significantly vary. Therefore, a coupling member, which is a part for coupling to a hub dynamo, needs to be produced to suit the shape, size, and type of the individual hub dynamo for use. The coupling member can be promptly produced using a 3D printer.
When the hub dynamo and the coupling member are coupled together, the size of the coupling holes of the coupling member needs to be adjusted according to the size of mounting screws. Since positions of coupling holes of a coupling member differ according to the hub dynamo, a coupling member needs to be produced to suit an individual hub dynamo for use.

A shape, size, structure, and material of the coupling member are not particularly limited, and may be appropriately selected according to the intended purpose.

Examples of the shape of the coupling member include sheet shapes and plate shapes.

Examples of the material of the coupling member include resins, rubber, and metals.

The size of the coupling member may be appropriately selected according to an individual hub dynamo for use.

The structure of the coupling member may be a single-layer structure or a multiple-layer structure.

The coupling member has a center hole, second coupling holes for coupling to the hub dynamo, which are disposed along the inner circumference of the coupling member, and third coupling holes for coupling to the first base or second base, which are disposed along the outer circumference of the coupling member.

The 3D printer is not particularly limited, and may be appropriately selected according to the intended purpose. Examples of the 3D printer include printers of a fused deposition modeling (FDM) system, a stereolithography system, a material jet system, a binder jet system, a powder bed fusion system, and a powder binding (adhesion) system. Since the part having the shape corresponding to the shape of the electric generator is modeled by a 3D printer, assembly of the hydroelectric power generator, maintenance, inspection, and replacement of damaged parts can be promptly carried out.

The periods actually required for exporting coupling members of hydroelectric power generator from Europe (U.K.) or Japan to the Philippines are presented in Table 1. For comparison, the period required for exporting coupling members of a hydroelectric power generator from Europe to Japan is also presented.

TABLE 1

| Exporting country | Importing country | Period |
|---|---|---|
| Europe (U.K.) | Japan | 4 days |
| Europe (U.K.) | Philippines | 3 weeks to 5 weeks |
| Japan | Philippines | 3 weeks to 5 weeks |

As presented in Table 1, it can be understood that it takes a longer period to export a coupling member of a hydroelectric power generator from Europe and Japan to the Philippines than exporting a coupling member of hydroelectric power generator from Europe to Japan. In addition, transportation costs and customs duties are incurred to import coupling members. Conversely, the repair can be carried out promptly and at a low cost, if the damaged part of the hydroelectric power generator is produced using a 3D printer at the place of use, namely, within the same country.

### <Assembling Step>

The assembling step is a step including assembling a hydroelectric power generator with a part having a shape corresponding to the shape of the electric generator.

Examples of the part having the shape corresponding to the shape of the electric generator include a coupling member for coupling a rotating assembly to an electric generator where the rotating assembly is rotatably coupled to a rotatable shaft.

The method for assembling the hydroelectric power generator is not particularly limited, and may be appropriately selected according to the intended purpose.

Examples of the method including fixing with screws, and fixing with a combination of bolts and nuts.

### <Model-Data Generation Step>

The model-data generation step is a step including acquiring information of a shape of the electric generator, and generating model data.

For example, the information of the shape of the electric generator can be acquired from the blueprint of the electric generator, photographs of the electric generator, scanned data of the electric generator, CAD data of the electric generator, etc. Model data is generated based on the information of the shape of the electric generator.

The model data is data acquired by 3D scanning etc., and is data that can be input to a 3D printer. The model data may be composed of one type of data, or several types of data.

The method for generating the model data is not particularly limited, and may be appropriately selected according to the intended purpose. Examples of the method include: a method of scanning an object that is a modeling target by 3D scanning; a method of modeling data using three-dimensional (3D) CAD software; and a method of generating data using a three-dimensional (3D) CG tool. For 3D scanning, a scanner integrated with the 3D printer may be used.

Surface model conversion of the model data is carried out to generate Standard Triangulated Language (STL)-format data.

Once the STL-format data is input to a 3D printer, the 3D printer converts the input STL-format data into a 2D image data set for printing.

The 2D image data set for printing is a data set including several kinds of 2D image data for printing. The 2D image data for printing is two-dimensional slice data obtained by slicing the STL-format data along the z-axial direction according to the resolution of the 3D printer. The model target is modeled using a 3D printer based on the 2D image data for printing.

### <Other Steps>

Other steps are not particularly limited, and may be appropriately selected according to the intended purpose. Examples of other steps include a controlling step, a washing step, and an inspection step.

According to the method for producing the hydroelectric power generator of the present disclosure, a hydroelectric power generator can be easily assembled at a place of use, and replacement of parts, repair, and maintenance can be promptly and easily carried out at a place of use, such as countries with emerging economies.

The hydroelectric power generator produced by the method for producing the hydroelectric power generator of the present invention can be installed in a small irrigation channel where installation of a typical hydroelectric power generator available in the related art is difficult. For example, the hydroelectric power generator can be installed in rivers, agricultural irrigation water, agricultural irrigation channels, industrial water, factories, buildings, drainage channels, such as of sewage plants, water channels inside plants, etc.

An embodiment of the hydroelectric power generator of the present disclosure will be described with reference to drawings hereinafter.

### <First Embodiment of Method for Producing Hydroelectric Power Generator>

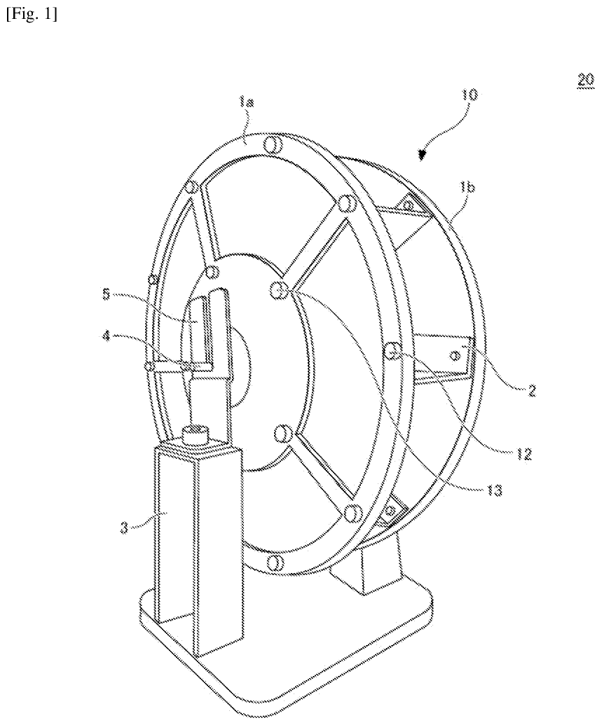

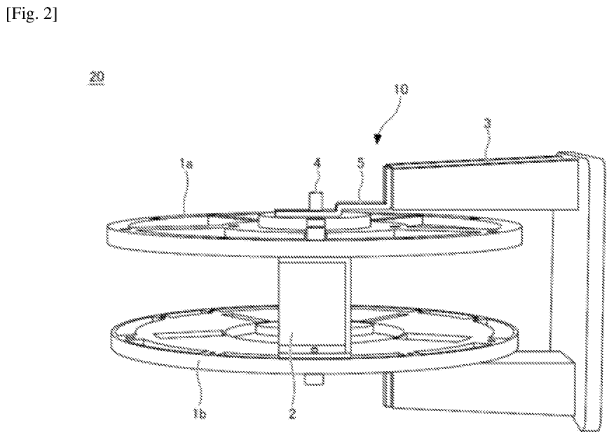

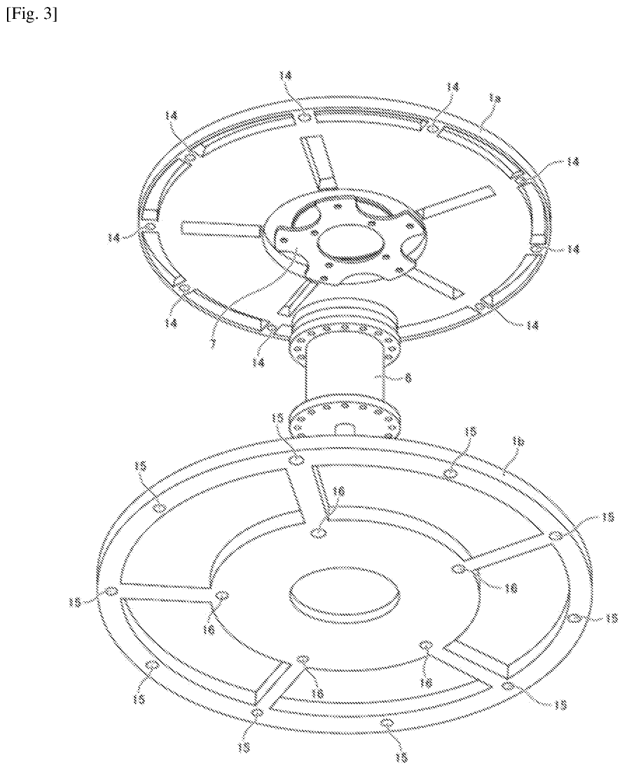

FIG. 1 is a perspective view illustrating one example of a hydroelectric power generator produced by the method for producing the hydroelectric power generator according to the present disclosure. FIG. 2 is a perspective view illustrating a side view of the example of the hydroelectric power generator. FIG. 3 is an exploded perspective view illustrating the example of the hydroelectric power generator.

The hydroelectric power generator 20 of FIG. 1 includes a rotatable shaft 4, a first base 1a and a second base 1b, blade structures (vanes) 2, and an electric generator 6. The first base 1a and second base 1b are rotatable together with the rotatable shaft 4, where the rotatable shaft 4 is disposed to pass through the first base 1a and the second base 1b, and the first base 1a and second base 1b are disposed to face each other. As the blade structures 2 receive pressure from water, the blade structures 2 rotate the first base 1a and second base 1b together with the rotatable shaft 4 that sits at a center of rotation. The electric generator 6 generates electricity as the rotatable shaft 4 is rotated.

In FIG. 1, the numeric reference 10 represents a rotating assembly (a combination of the first base 1a, the second base 1b, and the blade structures 2), the numeric reference 3 represents a rotating assembly holding member, the numeric reference 5 represents a rotatable-shaft supporting member, the numeric reference 12 represents a blade-structure mounting screw, and the numeric reference 13 represents an electric-generator mounting screw.

The first base 1a and second base 1b are rotatable together with the rotatable shaft 4, where the rotatable shaft 4 is disposed to pass through the first base 1a and second base 1b, and the first base 1a and second base 1b are disposed to face each other. The first base 1a and the second base 1b each have substantially a circular shape. The first base 1a and the second base 1b both have fourth coupling holes 16 for coupling to the coupling member 7.

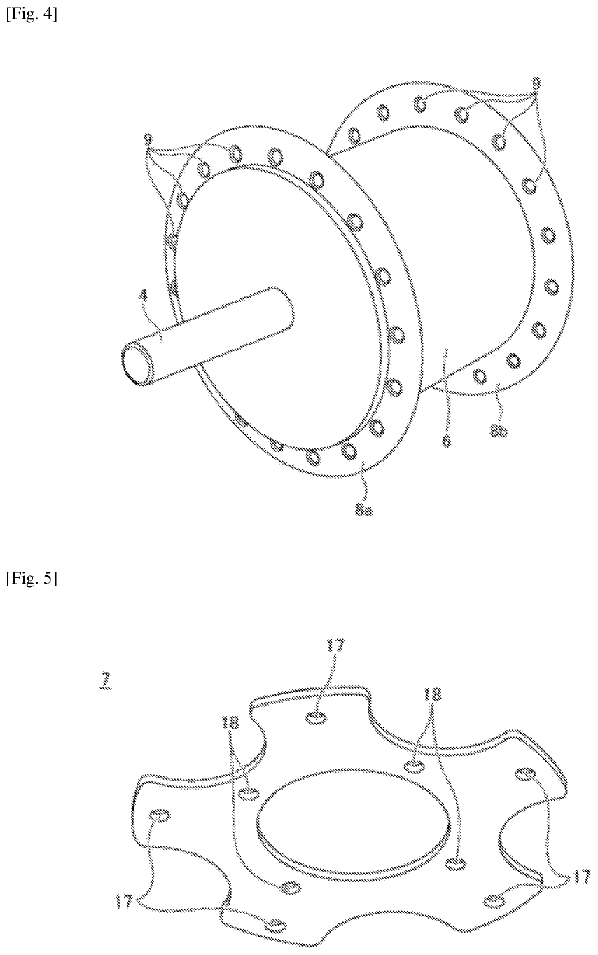

As the electric generator 6, a hub dynamo, which is typically used for lighting of bicycles, is used. As illustrated in FIG. 4, the hub dynamo serving as the electric generator 6 includes flanges 8a and 8b at the both ends of a cylindrical body, where each flange has a plurality of first coupling holes 9 for coupling to the coupling member 7. In FIG. 4, the numeric reference 4 represents a rotatable shaft, where electricity is generated as the rotatable shaft 4 is rotated.

The hub dynamo serving as the electric generator 6 is coupled to the first base 1a and the second base 1b each via the coupling member 7. Since the coupling is achieved via the coupling member 7, the hub dynamo serving as the electric generator 6 is stably and securely coupled and fixed to the first base 1a and second base 1b.

The coupling member 7 is a plate member having the shape as illustrated in FIG. 5. The coupling member 7 includes a center hole, second coupling holes 18 for coupling to the hub dynamo, which are disposed along the inner circumference of the coupling member 7, and third coupling holes 17 for coupling to the first base 1a and second base 1b, which are disposed along the outer circumference of the coupling member 7.

The method for mounting the first base 1a and the second base 1b on the hub dynamo serving as the electric generator 6 via the coupling member 7 is as follows. First, the first coupling holes 9 of each flange of the hub dynamo serving as the electric generator 6 and the second coupling holes 18 of the coupling member 7 are positioned and aligned, followed by fixing with screws. Next, the third coupling holes 17 of the coupling member 7 and the fourth coupling holes 16 of the first base 1a and second base 1b are positioned and aligned, followed by fixing with screws.

The blade structures 2 are box-shaped members that rotate the first base 1a and the second base 1b together with the rotatable shaft 4 that sits at a center of rotation, as the blade structures 2 receive water pressure. Each blade structure 2 has a plurality of first coupling holes and second coupling holes (not illustrated) for coupling to the first base 1a and the second base 1b.

As illustrated in FIG. 3, the first base 1a has first holes 14 corresponding to the first coupling holes of the blade structures 2, and the second base 1b has second holes 15 corresponding to the second coupling holes 15 of the blade structures 2.

The method for mounting the blade structures 2 between the first base 1a and the second base 1b is as follows. The screws 12 for mounting the blade structure are each arranged to pass through the first coupling hole of the blade structure 2 and the first hole 14 of the first base 1a, and another set of the screws 12 for mounting the blade structure are each arranged to pass through the second coupling hole of the blade structure 2 and the second hole 15 of the second base 1b to mount the blade structures 2 between the first base 1a and the second base 1b.

According to the method for producing the hydroelectric power generator of the first embodiment, the number of parts constituting the hydroelectric power generator is small, and the hydroelectric power generator can be easily assembled by fixing with screws. Moreover, replacement of parts, repairing, and maintenance can be promptly and easily carried out.

### <First Embodiment of Hydroelectric Power Generator>

The first embodiment of the hydroelectric power generator includes a rotatable shaft, a base A having a recess A at a surface of the base A, a base B having a recess B at a surface of the base B, one or more blade structures each having a projection a rotatably inserted into the recess A and a projection b rotatably inserted into the recess B, and an electric generator. The first embodiment of the hydroelectric power generator may further include other members, as necessary.

According to the first embodiment of the hydroelectric power generator, a hydroelectric power generator that can adjust the orientations and shapes of the blade structures according to pushing force and has improved mechanical strength can be provided.

An existing pico-hydroelectric power generator or micro-hydroelectric power generator can generate electricity using heavy and durable blade structures when a flow rate and flow speed of a water channel are appropriate. However, if a water flow is low, (1) the heavy and durable blade structures make a water wheel (rotor) difficult to rotate, reducing power generation. When (2) light blade structures are used and a water flow is fast, on the other hand, a water wheel is likely to suffer from physical damage, causing electrical damage due to excessive rotations of the water wheel or excessive power generation. As described above, an existing pico-hydroelectric power generator or micro-hydroelectric power generator cannot adjust rotations of blade structures or power generation efficiency according to the state of a water flow.

Therefore, proposed is, for example, a hydroelectric power generator that includes an (open-ended circumferential flow) water wheel, an electric generator, and a frame to which the (open-ended circumferential flow) water wheel and the electric generator are disposed, where the shape of each blade edge is a triangular shape, and the flume has a V-shape structure (see, for example, JP-A No. 2021-152343).

However, the hydroelectric power generator disclosed in JP-A No. 2021-152343 causes problems such that the water wheel is physically damaged by a fast water flow, and the electric generator or a device using the generated electricity may be electrically damaged by excessive rotations of the water wheel or excessive power generation.

Specifically, the existing plate-shape blade structures, as in JP-A No. 2021-152343, release the water flown onto each blade structure without retaining the water. Therefore, the water wheel cannot be efficiently rotated. According to the technology disclosed in JP-A No. 2021-152343, moreover, the easily rotatable blade structures for a slow water flow cannot be replaced with blade structures for a fast water flow, which do not rotate excessively, thus damage of the hydroelectric power generators caused by a fast water flow cannot be avoided.

In the first embodiment of the hydroelectric power generator, the hydroelectric power generator includes a rotatable shaft, a base A having a recess A at a surface of the base A and a base B having a recess B at a surface of the base B, one or more blade structures each having a projection a rotatably inserted into the recess A and a projection b rotatably inserted into the recess B, and a power generator that generates power by rotations of the rotatable shaft. The base A and the base B can rotate together with the rotatable shaft, and the base A and the base B are arranged to face each other. The blade structure rotates the base A and the base B together with the rotatable shaft that sits at a center of rotation, as a pushing force is received. Owing to the above-described structure, the projection a and projection b arranged on the blade structure function as a rotatable shaft of the blade structure to rotate the blade structure with the projection a and projection b. Therefore, the orientation (angle) and shape of the blade structure can be freely adjusted according to the water pressure (water flow) as a pushing force so that power generation can be efficiently performed regardless of water pressure. When the hydroelectric power generator is assembled, moreover, the projection a of the blade structure is engaged with the recess A of the base A, and the projection b of the blade structure is engaged with the recess B of the base B so that the mechanical durability of the hydroelectric power generator is improved. As a result, the blade structures can be replaced with light blade structures to facilitate rotation of the blade structures to improve efficiency of power generation when a water flow is low, and the blade structures are adjusted not to rotate excessively to avoid damage of the hydroelectric power generator when the water flow is fast.

In one aspect of the first embodiment of the hydroelectric power generator, the hydroelectric power generator includes a fixing member configured to fix the orientation of the blade structure with respect to the base A and the base B, where the blade structure can be rotated by the projection a and projection b. Owing to the above-described structure, the blade structure can be securely fixed to the base A and base B with the fixing member in the state where the orientation (angle) and shape of the blade structure are adjusted according to the water pressure (water flow) as a pushing force.

In one aspect of the first embodiment of the hydroelectric power generator, the blade structure includes a side wall a facing the base A, a side wall b facing the base B, a side wall c1 orthogonal to the side wall a and the side wall b, and a side wall c2 orthogonal to the side wall a and the side wall b and orthogonal to the side wall c1, where the projection a is disposed on the side wall a and the projection b is disposed on the side wall b. According to the above-described embodiment, the blade structure can be adjusted to a shape with which the water pressure (water flow) serving as a pushing force is not released, and the water flown onto the blade structure can be retained inside. Therefore, the base A and the base B can be efficiently rotated together with the rotatable shaft that sits at a center of rotation.

In one aspect of the first embodiment of the hydroelectric power generator, two or more holes a are disposed in the side wall a of the blade structure, and two or more holes b are disposed in the side wall b of the blade structure. Therefore, the orientation and shape of the blade structure can be appropriately adjusted according to the water pressure (water flow) serving as a pushing force. To freely adjust the orientation and shape of the blade structure relative to the water flow, 4 or more holes a are preferably disposed in the side wall a, and 4 or more holes b are preferably disposed in the side wall b.

In one aspect of the first embodiment of the hydroelectric power generator, the base A has a hole A corresponding to the hole a of the blade structure, and the base B has a hole B corresponding to the hole b of the blade structure, and the fixing member passes through the hole A and the hole a, and passes through the hole B and the hole b to fix the rotatable blade structure. Therefore, the blade structure can be securely fixed with the fixing member in the state where the orientation and shape of the blade structure are adjusted according to the water pressure (water flow) serving as a pushing force.

In one aspect of the first embodiment of the hydroelectric power generator, the fixing member is disposed on an outer edge of the base A and an outer edge of the base B. When the fixing member is disposed on the outer circumference of the base A and the outer circumference of the base B as in the above-described embodiment, mechanical strength of the hydroelectric power generator can be improved compared to the case where the fixing member is disposed at a center.

In one aspect of the first embodiment of the hydroelectric power generator, the blade structure has an identification mark adjacent to each of the holes A and the holes B, where the identification mark is to identify the position of each of the two or more holes A and the two or more holes B. Since the blade structure has the identification mark adjacent to each of the holes A and holes B for identifying the position of each hole among the two or more holes A and two or more holes B as in the above-described embodiment, the blade structure can be easily and securely mounted to the base A and the base B without any error in the mounting angle of the blade structure.

In one aspect of the first embodiment of the hydroelectric power generator, the hydroelectric power generator includes a plurality of the blade structures, and each of the blade structures has an identifier to identify a variety of each of the blade structures. Since there are two or more varieties of the blade structures and each blade structure has the identifier for identifying the variety of the blade structure as in the above-described embodiment, the two or more varieties of the blade structures can be surely assembled without any mistake.

Each member of the hydroelectric power generator according to the first embodiment can be appropriately selected from the descriptions of the hydroelectric power generator. Suitable embodiments of each member will be described hereinafter.

### —Rotatable Shaft—

The rotatable shaft is a member that is arranged to pass through the base A and the base B and rotates together with the base A and the base B. The shape, size, and material of the rotatable shaft are not particularly limited, and may be appropriately selected according to the intended purpose.

### —Base A and Base B—

The base A and the base B are members that are rotatable together with the rotatable shaft and are arranged to face each other. The base A and the base B are arranged so that the rotatable shaft passes through the base A and the base B. Shapes, sizes, materials, and structures of the base A and the base B are not particularly limited, and may be appropriately selected according to the intended purpose.

Examples of the material of the base A and the material of the base B include resins and metals. Among the above-listed examples, a resin is preferred in view of a reduction in weight of the base.

The base A has a recess A at a surface of the base A, where the projection a of the blade structure is rotatably inserted into the recess A.

The base B has a recess B at a surface of the base B, where the projection b of the blade structure is rotatably inserted into the recess B.

The shape and size of the recess A of the base A and the shape and size of the recess B of the base B are preferably shapes and sizes corresponding to the shapes and sizes of the projection a and projection b of the blade structure.

The base A has a hole A corresponding to the hole a of the blade structure. The fixing member passes through the hole A of the base A and the hole a of the blade structure to fix the rotatable blade structure.

The base B has a hole B corresponding to the hole b of the blade structure. The fixing member passes through the hole b of the base B and the hole b of the blade structure to fix the rotatable blade structure.

The number of the hole(s) A disposed in the base A is preferably one. The number of the hole(s) B disposed in the base B is preferably one. Owing to the above-described arrangement of the holes, the number of the fixing members used can be reduced to reduce the weight of the hydroelectric power generator.

The fixing member is a member configured to fix the orientation of the blade structure, which can be rotated by the projection a and the production b, onto the base A and the base B. Examples of the fixing member include screws, and nuts and bolts.

The fixing member is preferably disposed on the outer circumference of the base A and the outer circumference of the base B in view of improvement in mechanical strength of the hydroelectric power generator.

### —Blade Structures—

The blade structures are each a member configured to rotate the base A and the base B together with the rotatable shaft that sits at a center of rotation, as a pushing force is received. The shape, size, material, and variation of the blade structure are not particularly limited, and may be appropriately selected according to the intended purpose.

Examples of the material of the blade structure include resins and metals. Among the above-listed examples, a resin is preferred in view of a reduction in weight of the blade structure. Examples of the resins and metals include the resins and metals listed as the materials of the base A and base B.

Examples of the shape of the blade structure include box shapes. The shape of the blade structure is preferably a box shape because water generating a pushing force can be retained.

The blade structure has a side wall a facing the base A, a side wall b facing the base B, a side wall c1 orthogonal to the side wall a and side wall b, and a side wall c2 orthogonal to the side wall a and side wall b, and orthogonal to the side wall c1.

The side wall a of the blade structure preferably has two or more holes a, more preferably four or more holes a. The side wall b of the blade structure preferably has two or more holes b, more preferably four or more holes b. Owing to the above-described arrangement of holes, the orientation and shape of the blade structure can be adjusted according to the water pressure (water flow) of the pushing force.

The size of the blade structure may be appropriately selected according to the size of the hydroelectric power generator.

The variations of the blade structures are preferably two or more, more preferably four or more. Since two or more variations of the blade structures are used, the blade structure can be replaced by selecting from the two or more variations of the blade structures according to the water pressure (water flow) serving as a pushing force.

The blade structure preferably has an identifier configured to identify a variation of the blade structure. Examples of the identifier include letters, symbols, numbers, logos, colors, and any combination of the foregoing.

The blade structure has a projection a that is rotatably inserted into the recess A disposed at the surface of the base A.

The blade structure has a projection b that is rotatably inserted into the recess B disposed at the surface of the base B.

The projection a and projection b of the blade structure function as a rotatable shaft of the blade structure. Since the blade structure can be rotated by the projection a and the projection b, the orientation and shape of the blade structure can be freely adjusted according to the water pressure (water flow) serving as a pushing force.

The projection a and the projection b may be arranged concentrically or non-concentrically.

The shape of the projection a and the shape of the projection b are not particularly limited, and may be appropriately selected according to the intended purpose. The shape is preferably a cylinder because the projection is rotatable.

The pushing force is not particularly limited, except that the pushing force can rotate the base A and the base B together with the rotatable shaft that sits at a center of rotation. The pushing force may be appropriately selected according to the intended purpose. The pushing force is preferably water pressure (water flow). When the pushing force is water pressure, the electric generator is a hydroelectric power generator.

The blade structure has a hole a corresponding to the hole A of the base A. The blade structure has a hole b corresponding to the hole B of the base B. The fixing member passes through the hole A of the base A and the hole a of the blade structure to fix the rotatable blade structure.

The number of the holes a in the blade structure is preferably 2 or greater, more preferably 4 or greater.
The number of the holes b in the blade structure is preferably 2 or greater, more preferably 4 or greater.
The blade structure has an identification mark adjacent to the hole a or the hole b to identify the position of each hole among two or more holes a or two or more holes b. Since the identification mark is provided, the blade structure can be easily and surely mounted to the base A and the base B without an error in the mounting angle of the blade structure.
Examples of the identification mark include engravings, projections, numbers, symbols, and any combination of the foregoing.

The electric generator and other members may be appropriately selected from the descriptions of the hydroelectric power generator.

Embodiments of the hydroelectric power generator of the present disclosure will be described with reference to the figures. In the figures, the same numeric reference is given to the same constitutional component, and the duplicated description may be omitted. Moreover, the number, positions, shapes, etc. of the constitutional components are not limited to the following embodiments, may be suitably adjusted to carry out the present disclosure.

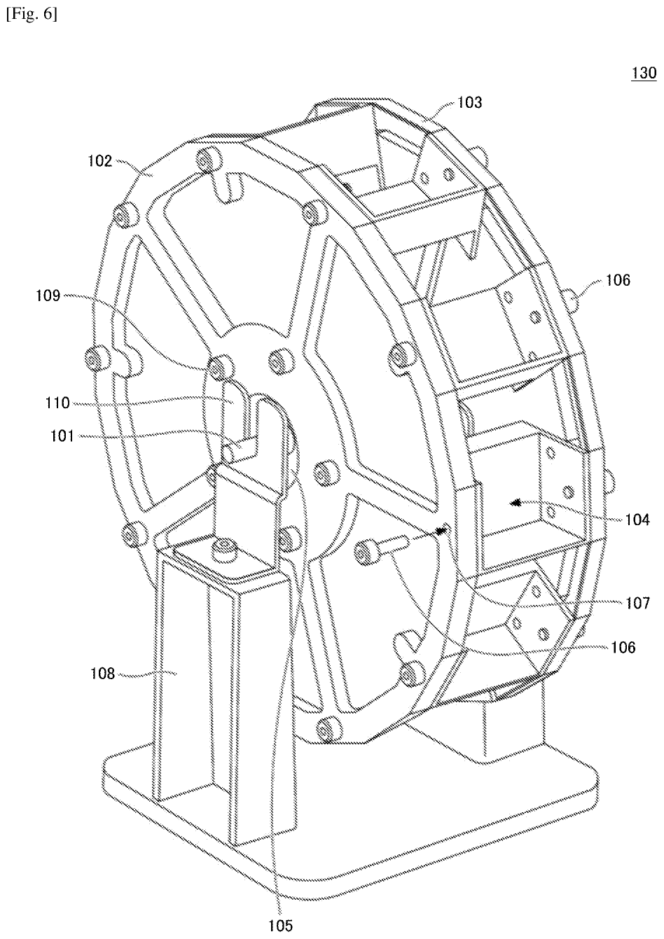

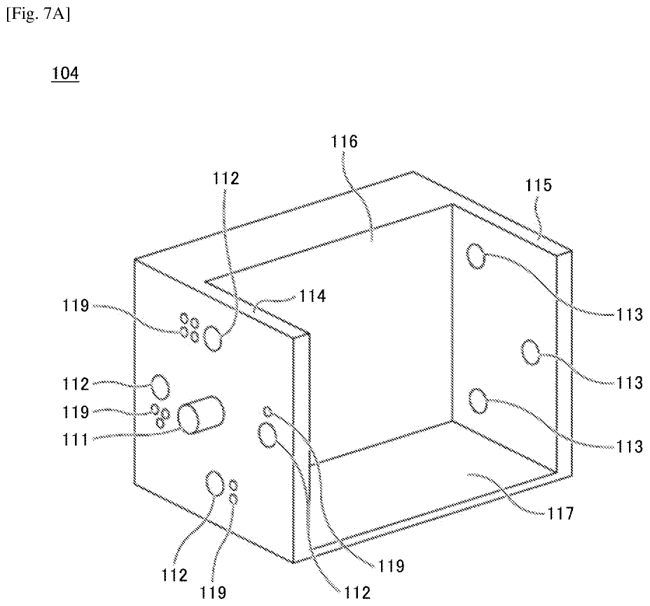

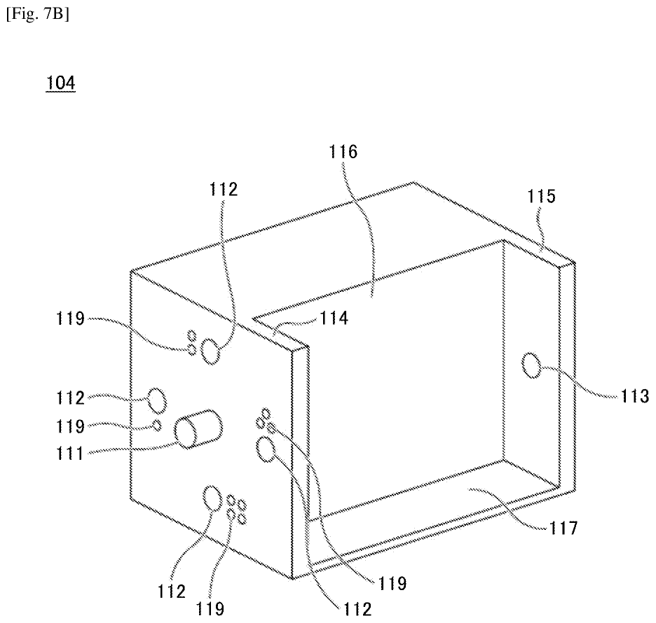

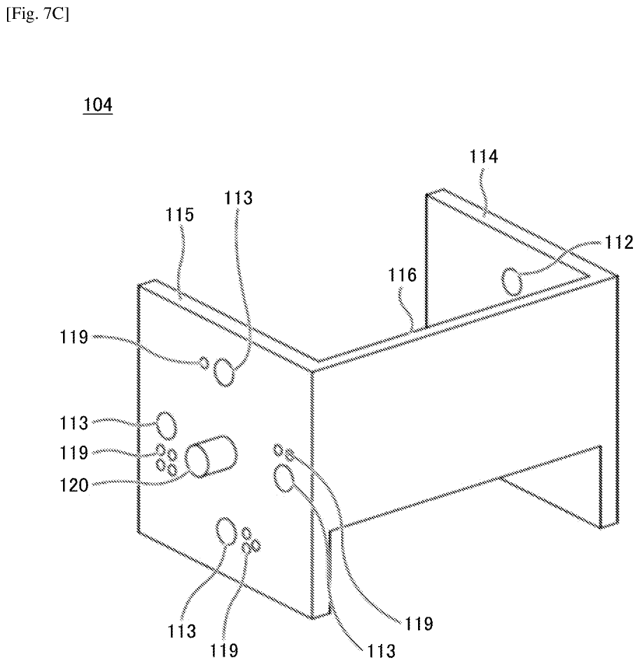

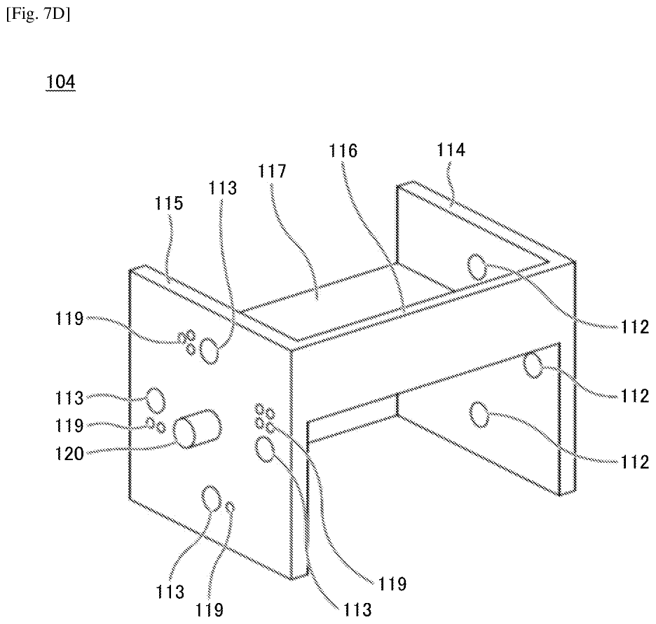

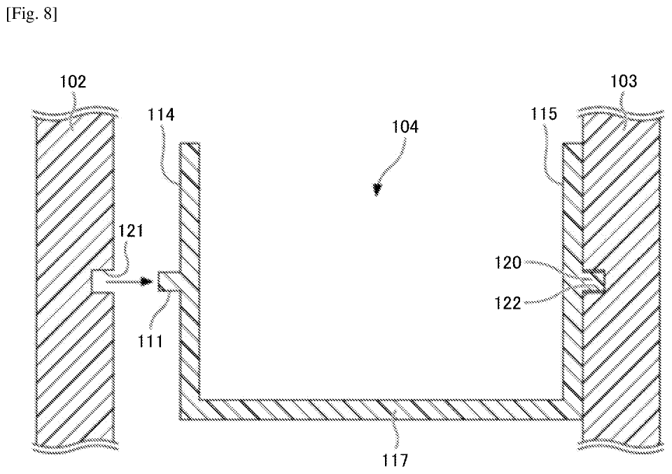

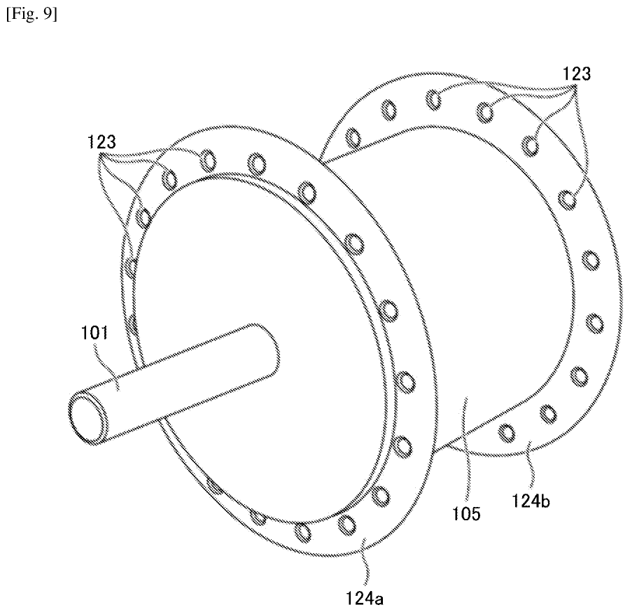

FIG. 6 is a perspective view illustrating an example of the hydroelectric power generator according to the first embodiment. FIGS. 7A to 7D are each a perspective view illustrating an example of a blade structure mounted in the hydroelectric power generator according to the first embodiment. FIG. 8 is a partial cross-sectional view illustrating a state where the blade structure is disposed between the base A and the base B. FIG. 9 is a perspective view illustrating an example of a hub dynamo serving as the electric generator.

The hydroelectric power generator 130 according to the first embodiment includes a rotatable shaft 101, a base A 102 having a recess A 121 at the surface of the base A, a base B 103 having a recess B 122 at the surface of the base B 103, blade structures 104 each having a projection a 111 and a projection b 120, where the projection a 111 can be rotatably inserted into the recess A 121 and the projection b 120 can be rotatably inserted into the recess B 122, and an electric generator 105. In FIG. 6, the numeric reference 106 represents a fixing member for the blade structure, the numeric reference 108 represents a holding member, the numeric reference 109 represents a fixing member for the electric generator, and the numeric reference 110 represents a member for retaining the rotatable shaft.

The base A 102 and the base B 103 are circular disk members that can be rotated together with the rotatable shaft 101 and are disposed to face each other, where the rotatable shaft 101 passes through the base A 102 and the base B 103.

The base A 102 has a recess A 121 at the surface of the base A 102. The projection a 111 of the blade structure 104 is rotatably inserted into the recess A 121.
The base B 103 has a recess B 122 at a surface of the base B 103. The projection b 120 of the blade structure 104 is rotatably inserted into the recess B 122.
The shape and size of the recess A 121 of the base A 102 and the shape and size of the recess B 122 of the base B 103 are shapes and sizes corresponding to the projection a 111 and projection b 120 of the blade structure 104, respectively.
The base A 102 has a hole A 107 corresponding to the hole a 112 of the blade structure 104. The blade structure fixing member 106 passes through the hole A 107 of the base A 102 and the hole a 112 of the blade structure to fix the rotatable blade structure 104. The base B 103 has a hole B (not illustrated) corresponding to the hole b 113 of the blade structure 104. The blade structure fixing member 106 passes through the hole B (not illustrated) of the base B 103 and the hole b 113 of the blade structure to fix the rotatable blade structure 104.

The blade structure 104 is a box-shaped member configured to rotate the base A 102 and the base B 103 together with the rotational shaft 101 that sits at a center of rotation, as the blade structure 104 receives a water flow serving as a pushing force.

The blade structure 104 includes a projection a 111 rotatably inserted into the recess A 121 of the base A 102, and a projection b 120 rotatably inserted into the recess B 122 of the base B 103.

As illustrated in FIG. 8, the projection a 111 of the blade structure 4 is rotatably inserted into the recess A 121 of the base A 102, and the projection b 120 of the blade structure 104 is rotatably inserted into the recess B 122 of the base B 103. Owing to the above-described structure, the projection a 111 and the projection b 120 function as a rotatable shaft of the blade structure 104 so that the blade structure 104 can be rotated by the projection a 111 and the projection b 120. Therefore, the orientation and shape of the blade structure can be freely adjusted according to the water pressure (water flow) serving as a pushing force.

As illustrated in FIGS. 7A to 7D, the shape and structure of the blade structure 104 are appropriately selected according to the water flow and water amount.

As illustrated in FIGS. 7A to 7D, the blade structure 104 includes a side wall a 114 facing the base A 102, a side wall b 115 facing the base B 103, a side wall c1 (116) orthogonal to the side wall a 114 and the side wall b 115, and a side wall c2 (117) orthogonal to the side wall a 114 and the side wall b 115, and orthogonal to the side wall c1 (116).

As illustrated in FIGS. 7A and 7C, moreover, the blade structure 104 includes a side wall a 114 facing the base A 102, a side wall b 115 facing the base B 103, a side wall c1 (116) orthogonal to the side wall a 114 and the side wall b 115, and a side wall c2 (117) orthogonal to the side wall a 114 and the side wall b 115, and orthogonal to the side wall c1 (116).

The projection a 111 is disposed on the side wall a 114, and the projection b 120 is disposed on the side wall b 115. Moreover, the side wall a 114 has four holes a 112, and the side wall b 115 has four holes b 113.
As illustrated in FIGS. 7A to 7D, the blade structure 104 has an identification mark 119 adjacent to each of the holes a 112 and the holes b 113 to identify the position of each of the four holes A 112 and the four holes b 113. Owing to the identification marks, the blade structure 104 can be easily and surely mounted to the base A 102 and the base B 103 without an error in the orientation (angle) of the blade structure 104.
Four types of the blade structure 104 are used, and the four blade structures 104 each has an identifier to identify the variation of the blade structure 4. Owing to the identifier, the two or more variations of the blade structures can be surely assembled without any error.

As the electric generator 105, a hub dynamo, which is typically used as lighting of a bicycle, is used. The hub dynamo serving as the electric generator 105 has flanges 124a and 124b dispose at both ends of the cylindrical body as illustrated in FIG. 9. Each flange has a plurality of coupling holes 123 to couple to a connection member (not illustrated). In FIG. 9, the numeric reference 101 represents a rotatable shaft. Power generation is performed by rotating the rotatable shaft 101.

The hub dynamo serving as the electric generator 105 is coupled to the base A 102 and the base B 103 with the fixing member 109 for the electric generator via a coupling member. Since the connection is made via the coupling member, the hub dynamo serving as the electric generator 105 can be stably and surely fixed to the base A 102 and the base B 103.

The hydroelectric power generator according to the first embodiment can adjust the orientation and shape of the blade structure according to a pushing force and has improved mechanical strength. Moreover, the number of parts constituting the hydroelectric power generator is small, and the hydroelectric power generator can be easily assembled by screwing, In addition, replacement of parts, fixing, and maintenance of the hydroelectric power generator are promptly and easily performed.

### First Comparative Embodiment

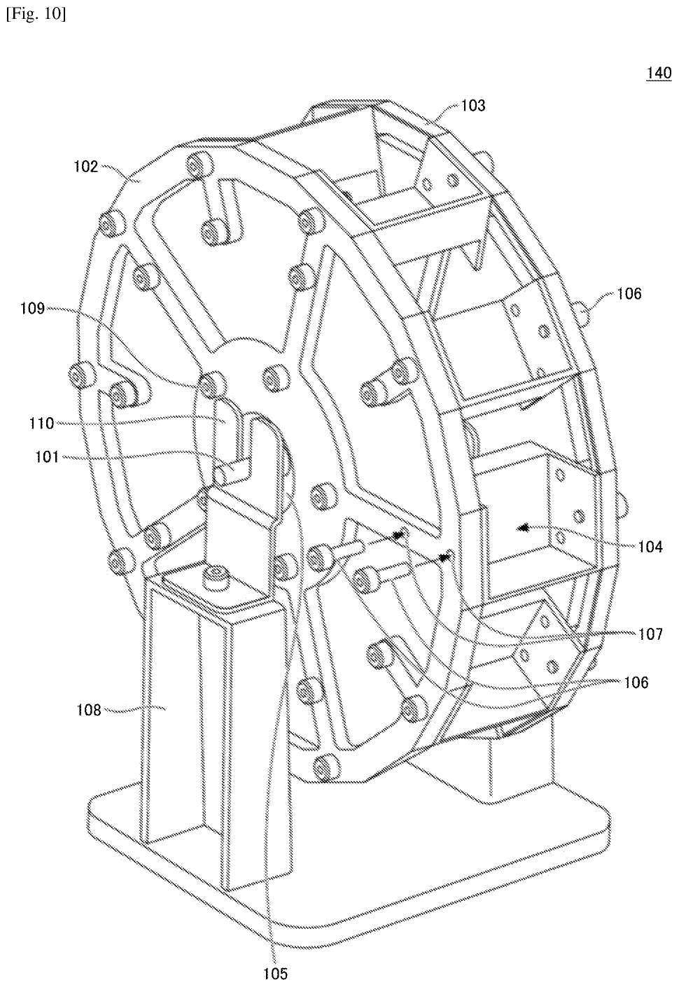

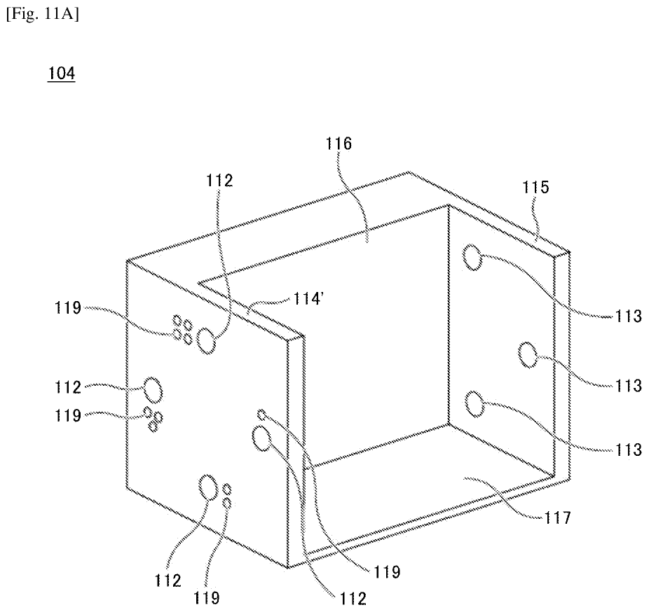

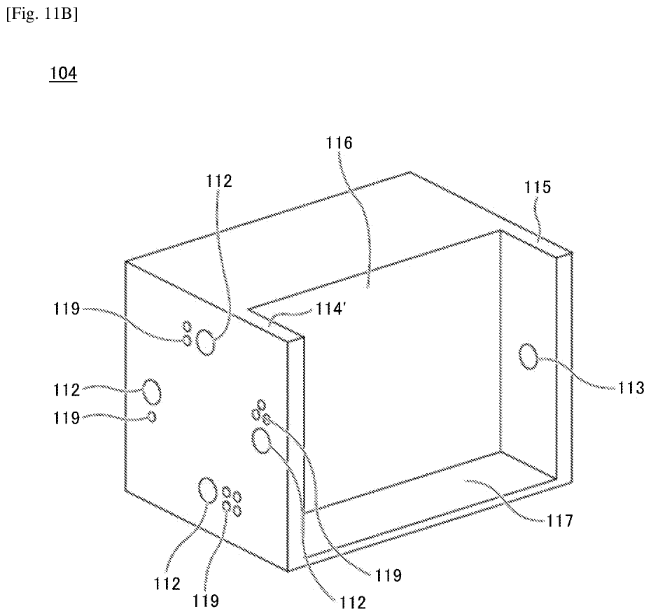

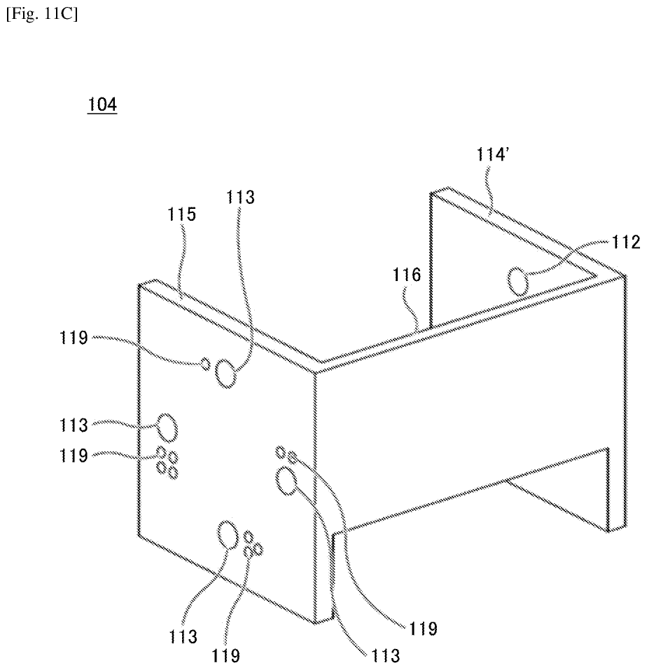

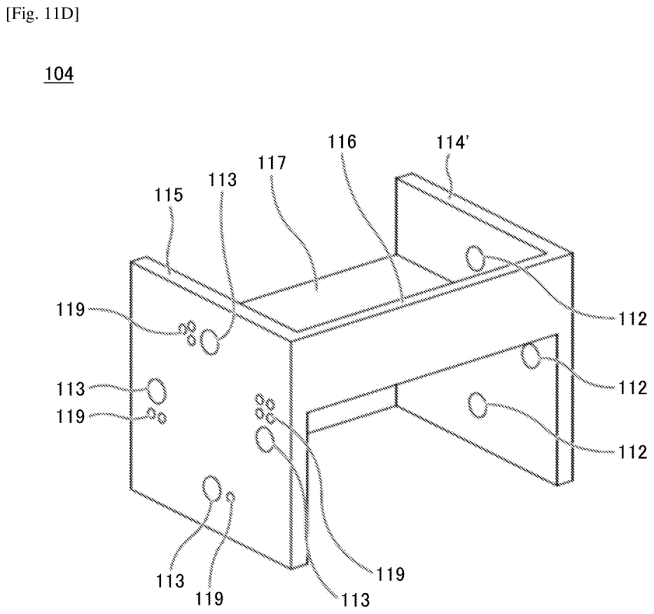

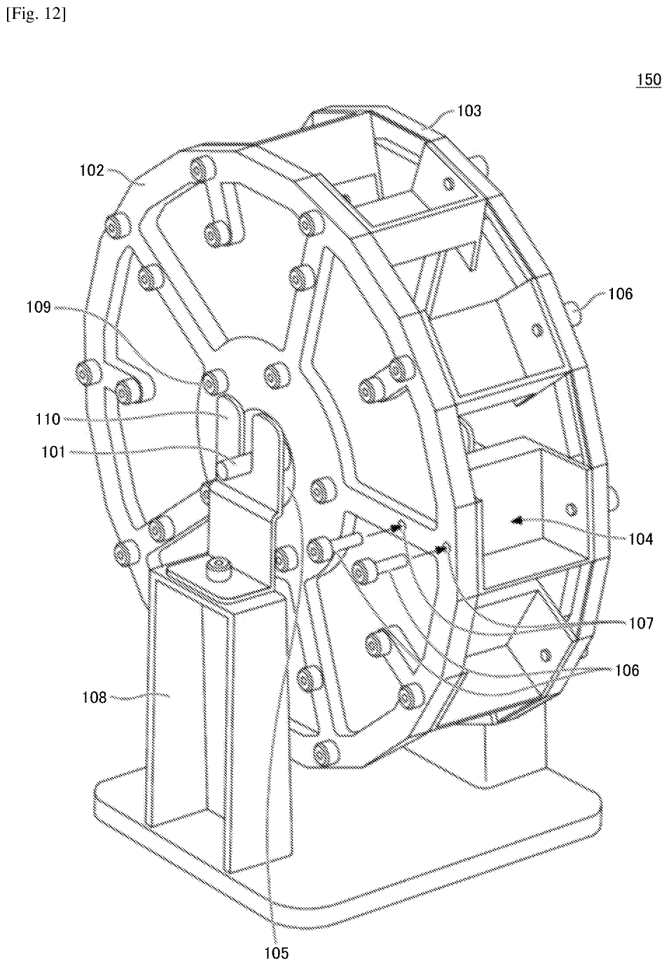

FIG. 10 is a perspective view illustrating an example of the first comparative embodiment of the hydroelectric power generator. FIGS. 11A to 11D are perspective views each illustrating an example of a blade structure mounted in the hydroelectric power generator according to the first comparative embodiment.

The first comparative embodiment of the hydroelectric power generator 140 is identical to the first embodiment of the hydroelectric power generator 130, except that the blade structure 104′ of FIGS. 11A to 11D that does not have a projection a 111 and a projection b 120 is used instead of the blade structure 104 of FIGS. 7A to 7D of the first embodiment, and the base A and the base B are fixed to the blade structure 104′ with four fixing members 106 for the blade structure. In the first comparative embodiment, a structure identical to the already described first embodiment has the same numeric reference, and the description for the same structure may be omitted.
The hydroelectric power generator 140 according to the first comparative embodiment can adjust the orientation of each of the four blade structures of FIGS. 11A to 11D at a certain degree. Since the blade structure is fixed to the base A and the base B with four fixing members, more steps need to be performed. Moreover, the mechanical strength is reduced compared to the first embodiment, as the blade structure does not have projections engaged with recesses of the base A and the base B.

### Second Comparative Embodiment

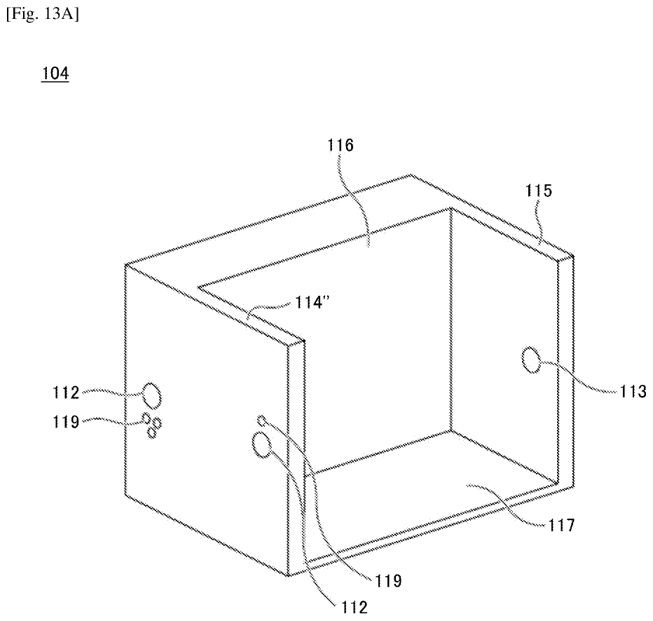

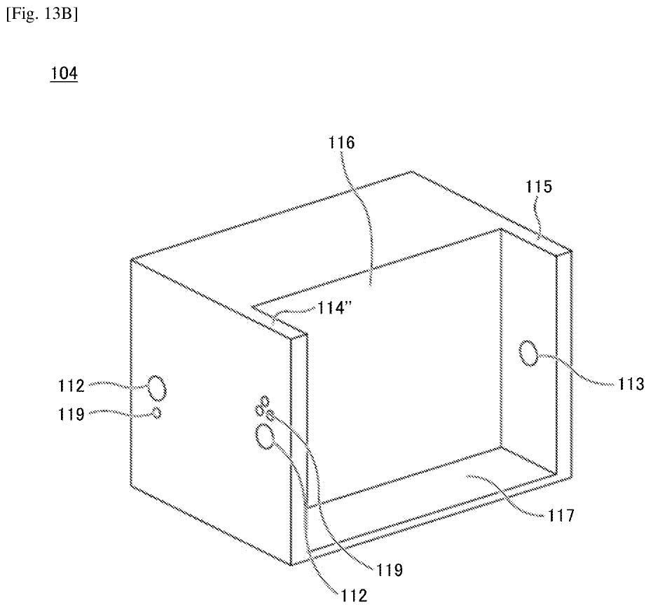

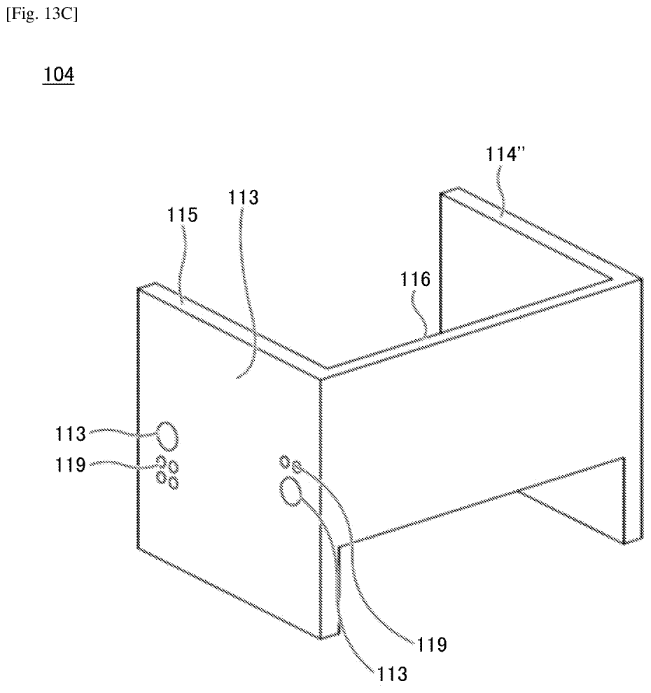

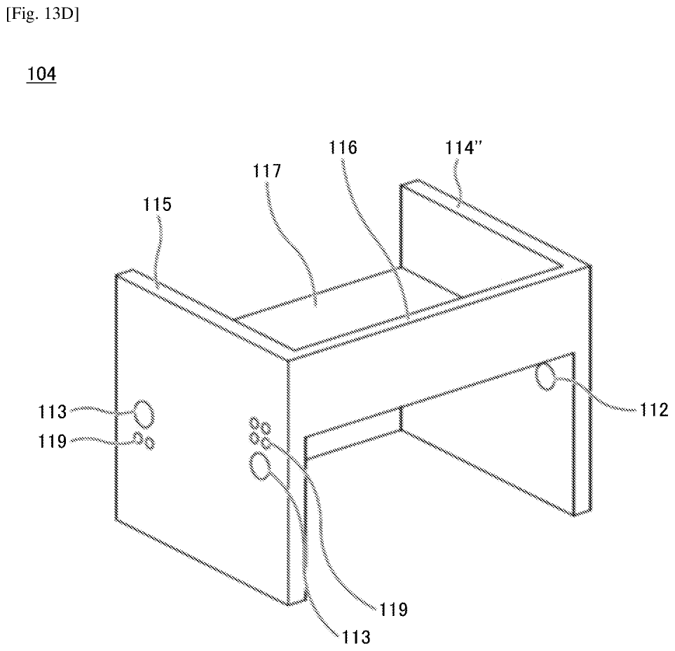

FIG. 12 is a perspective view illustrating an example of the hydroelectric power generator according to the second comparative embodiment. FIGS. 13A to 13D are perspective views each illustrating an example of a blade structure mounted in the hydroelectric power generator according to the second comparative embodiment.

The hydroelectric power generator 150 according to the second comparative embodiment is identical to the hydroelectric power generator 130 according to the first embodiment, except that, instead of the blade structure 104 of FIGS. 7A to 7D of the first embodiment, the blade structure 104″ of FIGS. 13A to 13D that does not have the projection a 111 and the projection b 120, but has two holes a 112 and two holes b 113 is used, and the blade structure 104″ is fixed to the base A and the base B with four fixing members 106 for the blade structure. In the comparative embodiment 2, a structure identical to the already described embodiment 1 has the same numeric reference, and the description for the same structure may be omitted.

In the comparative embodiment 2 of the hydroelectric power generator, the directions of the four blade structures of FIGS. 13A to 13D are fixed, more steps are necessary to fix the blade structure 4 to the base A and the base B as four fixing members are used, and the mechanical strength is reduced compared to the first embodiment because the blade structure does not have projections engaged with the recesses of the base A and the base B.

### EXAMPLES

Examples of the present disclosure will be described hereinafter, but Examples shall not be construed as limiting the scope of the present disclosure in any way.

### Example 1

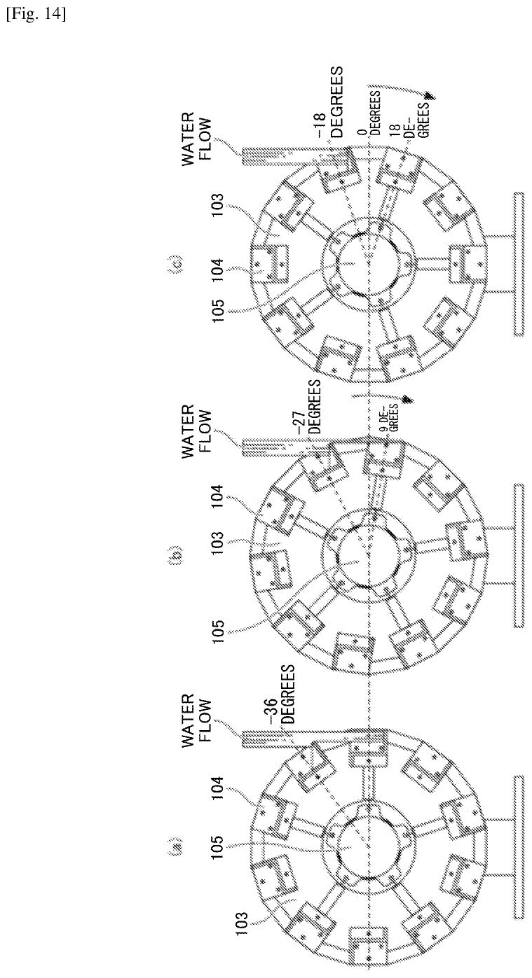

In Example 1, the hydroelectric power generator 130 according to the first embodiment illustrated in FIG. 6, in which the blade structure of FIG. 7A was mounted, was used, and torque was evaluated with 0 degree-rotation ((a) in FIG. 14), 9 degree-rotation ((b) in FIG. 14), and 18 degree-rotation ((c) in FIG. 14), based on the following criteria. The results are presented below. Note that, (a) to (c) in FIG. 14 are plane views each illustrating a state where the base A 102 is removed from the hydroelectric power generator 130.

### —Evaluation Criteria—

5: Very high torque
4: High torque
3: Ordinary level of torque
2: Low torque
1: Very low torque

(1) At the 0 degree-rotation of (a) in FIG. 14, the amount of the water retained in the blade structure positioned at −36 degrees is 80% relative to a total amount of the water the blade structure can hold. Moreover, the amount of the water applied to the blade structure positioned at −36 degrees is 20% relative to a total amount of the water applied. Furthermore, the amount of the water applied to the blade structure positioned at 0 degrees is 80% relative to a total amount of the water applied. Accordingly, the torque at the 0 degree-rotation of (a) in FIG. 14 is “5” in 5 ranks.

(2) At the 9 degree-rotation of (b) in FIG. 14, the amount of the water retained in the blade structure positioned at −27 degrees is 70% relative to a total amount of the water the blade structure can hold. Moreover, the amount of the water applied to the blade structure positioned at −27 degrees is 90% relative to a total amount of the water applied. Furthermore, the amount of the water applied to the blade structure positioned at 9 degrees is 0% relative to a total amount of the water applied. Accordingly, the torque at the 9 degree-rotation of (b) in FIG. 14 is “4” in 5 ranks.

(3) At the 18 degree-rotation of (c) in FIG. 14, the amount of the water retained in the blade structure positioned at −18 degrees is 60% relative to a total amount of the water the blade structure can hold. Moreover, the amount of the water applied to the blade structure positioned at −18 degrees is 100% (a whole) relative to a total amount of the water applied. Furthermore, the amount of the water applied to the blade structure positioned at 18 degrees is 0% relative to a total amount of the water applied. Accordingly, the torque at the 18 degree-rotation of (c) in FIG. 14 is “4” in 5 ranks.

As described above, the total of the torque of the hydroelectric power generator of Example 1 is “13.”

### Example 2

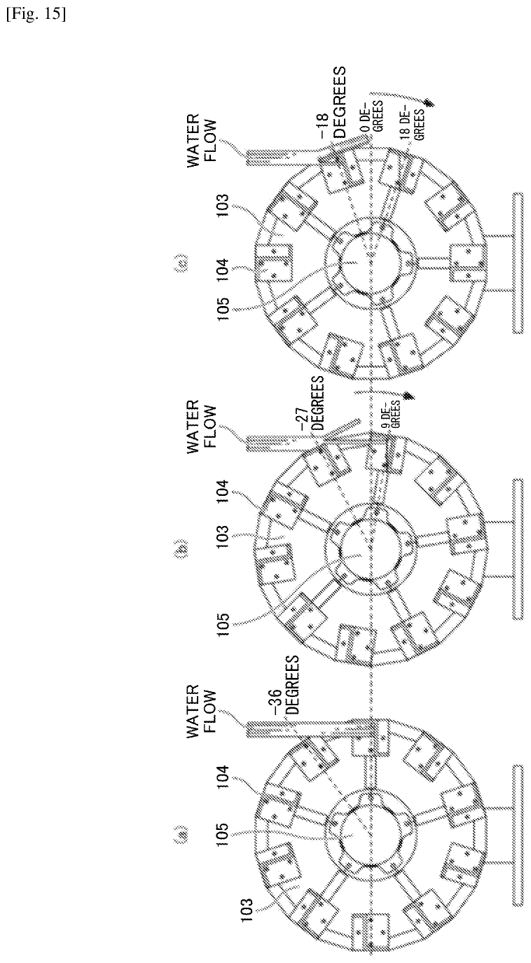

In Example 2, the hydroelectric power generator 130 according to the first embodiment illustrated in FIG. 6, in which the blade structure of FIG. 7B was mounted, was used, and torque was evaluated with 0 degree-rotation ((a) in FIG. 15), 9 degree-rotation ((b) in FIG. 15), and 18 degree-rotation ((c) in FIG. 15), based on the same criteria as in Example 1. The results are presented below. Note that, (a) to (c) in FIG. 15 are plane views each illustrating a state where the base A 102 is removed from the hydroelectric power generator 130.

(1) At the 0 degree-rotation of (a) in FIG. 15, the amount of the water retained in the blade structure positioned at −36 degrees is 0% relative to a total amount of the water the blade structure can hold. Moreover, the amount of the water applied to the blade structure positioned at −36 degrees is 0% relative to a total amount of the water applied. Furthermore, the amount of the water applied to the blade structure positioned at 0 degrees is 100% (a whole) relative to a total amount of the water applied. Accordingly, the torque at the 0 degree-rotation of (a) in FIG. 15 is “4” in 5 ranks.

(2) At the 9 degree-rotation of (b) in FIG. 15, the amount of the water retained in the blade structure positioned at −27 degrees is 0% relative to a total amount of the water the blade structure can hold. Moreover, the amount of the water applied to the blade structure positioned at −27 degrees is 20% relative to a total amount of the water applied. Furthermore, the amount of the water applied to the blade structure positioned at 9 degrees is 60% relative to a total amount of the water applied. Accordingly, the torque at the 9 degree-rotation of (b) in FIG. 15 is “1” in 5 ranks.

(3) At the 18 degree-rotation of (c) in FIG. 15, the amount of the water retained in the blade structure positioned at −18 degrees is 20% relative to a total amount of the water the blade structure can hold. Moreover, the amount of the water applied to the blade structure positioned at −18 degrees is 0% relative to a total amount of the water applied. Furthermore, the amount of the water applied to the blade structure positioned at 18 degrees is 80% relative to a total amount of the water applied. Accordingly, the torque at the 18 degree-rotation of (c) in FIG. 15 is “2” in 5 ranks.

As described above, the total of the torque of the hydroelectric power generator of Example 2 is “7.”

### Example 3

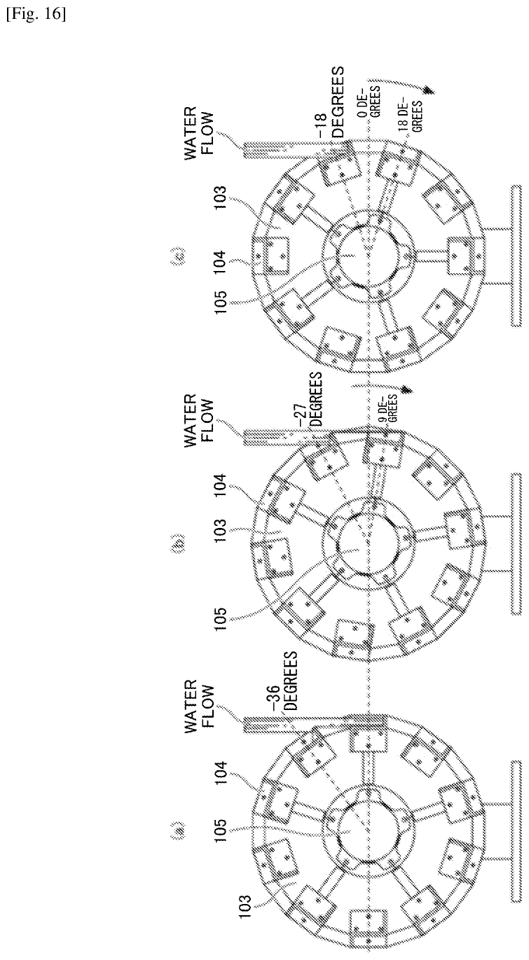

In Example 3, the hydroelectric power generator 130 according to the first embodiment illustrated in FIG. 6, in which the blade structure of FIG. 7C was mounted, was used, and torque was evaluated with 0 degree-rotation ((a) in FIG. 16), 9 degree-rotation ((b) in FIG. 16), and 18 degree-rotation ((c) in FIG. 16), based on the same criteria as in Example 1. The results are presented below. Note that, (a) to (c) in FIG. 16 are plane views each illustrating a state where the base A 102 is removed from the hydroelectric power generator 130.

(1) At the 0 degree-rotation of (a) in FIG. 16, the amount of the water retained in the blade structure positioned at −36 degrees is 40% relative to a total amount of the water the blade structure can hold. Moreover, the amount of the water applied to the blade structure positioned at −36 degrees is 20% relative to a total amount of the water applied. Furthermore, the amount of the water applied to the blade structure positioned at 0 degrees is 80% relative to a total amount of the water applied. Accordingly, the torque at the 0 degree-rotation of (a) in FIG. 16 is “4” in 5 ranks.

(2) At the 9 degree-rotation of (b) in FIG. 16, the amount of the water retained in the blade structure positioned at −27 degrees is 30% relative to a total amount of the water the blade structure can hold. Moreover, the amount of the water applied to the blade structure positioned at −27 degrees is 90% relative to a total amount of the water applied. Furthermore, the amount of the water applied to the blade structure positioned at 9 degrees is 0% relative to a total amount of the water applied. Accordingly, the torque at the 9 degree-rotation of (b) in FIG. 16 is “4” in 5 ranks.

(3) At the 18 degree-rotation of (c) in FIG. 16, the amount of the water retained in the blade structure positioned at −18 degrees is 20% relative to a total amount of the water the blade structure can hold. Moreover, the amount of the water applied to the blade structure positioned at −18 degrees is 100% (a whole) relative to a total amount of the water applied. Furthermore, the amount of the water applied to the blade structure positioned at 18 degrees is 0% relative to a total amount of the water applied. Accordingly, the torque at the 18 degree-rotation of (c) in FIG. 16 is “4” in 5 ranks.

As described above, the total of the torque of the hydroelectric power generator of Example 3 is “12.”

### Example 4

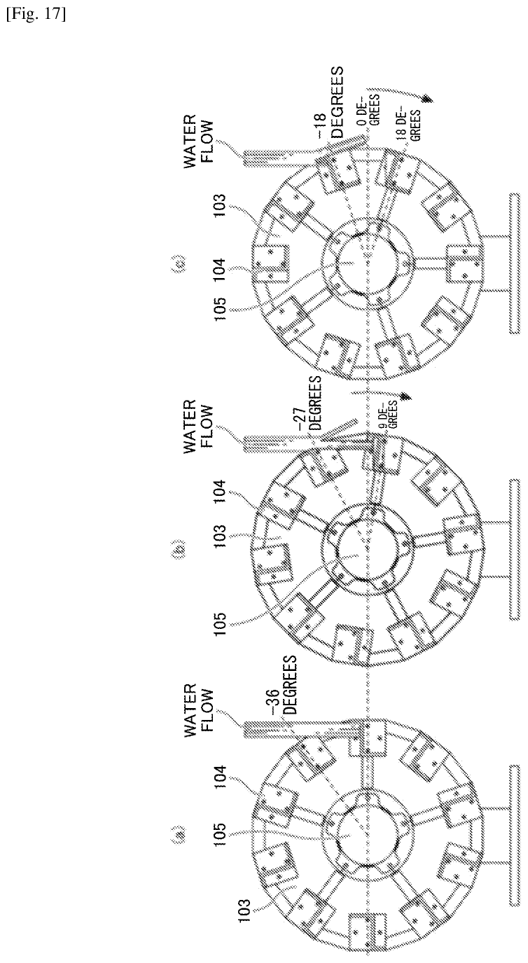

In Example 4, the hydroelectric power generator 130 according to the first embodiment illustrated in FIG. 6, in which the blade structure of FIG. 7C was mounted, was used, and torque was evaluated with 0 degree-rotation ((a) in FIG. 17), 9 degree-rotation ((b) in FIG. 17), and 18 degree-rotation ((c) in FIG. 17), based on the same criteria as in Example 1. The results are presented below. Note that, (a) to (c) in FIG. 17 are plane views each illustrating a state where the base A 102 is removed from the hydroelectric power generator 130.

(1) At the 0 degree-rotation of (a) in FIG. 17, the amount of the water retained in the blade structure positioned at −36 degrees is 0% relative to a total amount of the water the blade structure can hold. Moreover, the amount of the water applied to the blade structure positioned at −36 degrees is 0% relative to a total amount of the water applied. Furthermore, the amount of the water applied to the blade structure positioned at 0 degrees is 100% (a whole) relative to a total amount of the water applied. Accordingly, the torque at the 0 degree-rotation of (a) in FIG. 17 is “4” in 5 ranks.

(2) At the 9 degree-rotation of (b) in FIG. 17, the amount of the water retained in the blade structure positioned at −27 degrees is 0% relative to a total amount of the water the blade structure can hold. Moreover, the amount of the water applied to the blade structure positioned at −27 degrees is 50% relative to a total amount of the water applied. Furthermore, the amount of the water applied to the blade structure positioned at 9 degrees is 70% relative to a total amount of the water applied. Accordingly, the torque at the 9 degree-rotation of (b) in FIG. 17 is “3” in 5 ranks.

(3) At the 18 degree-rotation of (c) in FIG. 17, the amount of the water retained in the blade structure positioned at −18 degrees is 20% relative to a total amount of the water the blade structure can hold. Moreover, the amount of the water applied to the blade structure positioned at −18 degrees is 0% relative to a total amount of the water applied. Furthermore, the amount of the water applied to the blade structure positioned at 18 degrees is 80% relative to a total amount of the water applied. Accordingly, the torque at the 18 degree-rotation of (c) in FIG. 17 is “2” in 5 ranks.

As described above, the total of the torque of the hydroelectric power generator of Example 4 is “9.”

The evaluation results of the torque of Examples 1 to 4 are summarized in Table 1.

TABLE 2

| | Blade structure | Torque (total) |
|---|---|---|
| Ex. 1 | FIG. 7A | 13 |
| Ex. 2 | FIG. 7B | 7 |
| Ex. 3 | FIG. 7C | 12 |
| Ex. 4 | FIG. 7D | 9 |

It was found from the results in Table 1 that the torque was the higher in the order of Example 1, Example 3, Example 4, and Example 2 (i.e., Example 1>Example 3>Example 4>Example 2).

For example, embodiments of the present disclosure are as follows.

<1> A method for producing a hydroelectric power generator, including:
modeling a part having a shape corresponding to a shape of an electric generator using a 3D printer; and
assembling a hydroelectric power generator with the part having the shape corresponding to the shape of the electric generator.

<2> The method according to <1>, further including:
acquiring information of the shape of the electric generator and generating model data.

<3> The method according to <1> or <2>,
wherein the part having the shape corresponding to the shape of the electric generator is a coupling member configured to couple a rotating assembly to the electric generator, where the rotating assembly is rotatably coupled to a rotatable shaft.

<4> The method according to <3>,
wherein at least part of the rotating assembly includes a recycled plastic material, or a bioplastic material, or both.

<5> The method according to <1> or <2>,
wherein the electric generator is a hub dynamo.

<6> A hydroelectric power generator, including:
a rotatable shaft;
a base A having a recess A at a surface of the base A, and a base B having a recess B at a surface of the base B, where the base A and the base B are arranged to face each other, and the rotatable shaft is arranged to pass through the base A and the base B to rotate the base A and the base B together with the rotatable shaft;
one or more blade structures each having a projection a rotatably inserted into the recess A and a projection b rotatably inserted into the recess B, where each blade structure is configured to rotate the base A and the base B together with the rotatable shaft that sits at a center of rotation, as the blade structure receives a pushing force; and an electric generator configured to generate electricity, as the rotatable shaft rotates.

<7> The hydroelectric power generator according to <6>, further including:
one or more fixing members configured to fix an orientation of the blade structure rotatable with the projection a and the projection b, with respect to the base A and the base B.

<8> The hydroelectric power generator according to <6> or <7>,
wherein the blade structure includes
a side wall a facing the base A,
a side wall b facing the base B, and
a side wall c1 orthogonal to the side wall a and the side wall b,
where the projection a is disposed on the side wall a, and the projection b is disposed on the side wall b.

<9> The hydroelectric power generator according to <8>,
wherein the side wall a of the blade structure has two or more holes a, and the side wall b of the blade structure has two or more holes b.

<10> The hydroelectric power generator according to <9>,
wherein the base A has a hole A corresponding to the hole a of the blade structure, and the base B has a hole B corresponding to the hole b of the blade structure,
wherein one fixing member of the one or more fixing members passes through the hole A and the hole a, and another fixing member of the one or more fixing members passes through the hole B and the hole b to fix the rotatable blade structure.

<11> The hydroelectric power generator according to <10>,
wherein one fixing member of the one or more fixing members is arranged on an outer edge of the base A and another fixing member of the one or more fixing members is arranged on an outer edge of the base B.

<12> The hydroelectric power generator according to <9>,
wherein the blade structure includes an identification mark adjacent to each of the holes a and the holes b to identify a position of each hole among the two or more holes a and the two or more holes b.

<13> The hydroelectric power generator according to <6> or <7>,
wherein the hydroelectric power generator includes a plurality of the blade structures, where each of the blade structures includes an identifier to identify a variety of each of the blade structures.

According to the method for producing a hydroelectric power generator as in any one of <1> to <5>, and the hydroelectric power generator as in any one of <6> to <13>, the above-described various problems existing in the related art can be solved, and the object of the present disclosure can be achieved.

### DESCRIPTION OF SYMBOLS

1a first base
1b second base
2 blade structure
3 rotating assembly holding member
4 rotatable shaft
5 rotatable shaft supporting member
6 electric generator
7 coupling member
8a, 8b flange
9 first coupling hole
10 rotating assembly
20 hydroelectric power generator
101 rotatable shaft
102 base A
103 base B
104 blade structure
105 electric generator
106 fixing member for blade structure
107 hole A
108 holding member
109 fixing member for electric generator
110 member for retaining rotatable shaft
111 projection a
112 hole a
113 hole b
114 side wall a
115 side wall b
116 side wall c1
117 side wall c2
119 identification mark
120 projection b
121 recess A
122 recess B
130 hydroelectric power generator
140 hydroelectric power generator
150 hydroelectric power generator

The present application is based on and claims priority to Japanese patent application No. 2022-157366 filed on Sep. 30, 2022, and Japanese patent application No. 2022-159470 filed on Oct. 3, 2022, with the Japanese Patent Office, the entire contents of which are hereby incorporated by reference.

1. A method for producing a hydroelectric power generator, comprising:
modeling a part having a shape corresponding to a shape of an electric generator using a 3D printer; and
assembling a hydroelectric power generator with the part having the shape corresponding to the shape of the electric generator.

2. The method according to claim 1, further comprising:
acquiring information of the shape of the electric generator and generating model data.

3. The method according to claim 1,
wherein the part having the shape corresponding to the shape of the electric generator is a coupling member configured to couple a rotating assembly to the electric generator, where the rotating assembly is rotatably coupled to a rotatable shaft.

4. The method according to claim 3,
wherein at least part of the rotating assembly includes a recycled plastic material, or a bioplastic material, or both.

5. The method according to claim 1,
wherein the electric generator is a hub dynamo.

6. A hydroelectric power generator, comprising:
a rotatable shaft;
a base A having a recess A at a surface of the base A, and a base B having a recess B at a surface of the base B, where the base A and the base B are arranged to face each other, and the rotatable shaft is arranged to pass through the base A and the base B to rotate the base A and the base B together with the rotatable shaft;
one or more blade structures each having a projection a rotatably inserted into the recess A and a projection b rotatably inserted into the recess B, where each blade structure is configured to rotate the base A and the base B together with the rotatable shaft that sits at a center of rotation, as the blade structure receives a pushing force; and
an electric generator configured to generate electricity, as the rotatable shaft rotates.

7. The hydroelectric power generator according to claim 6, further comprising:
one or more fixing members configured to fix an orientation of the blade structure rotatable with the projection a and the projection b, with respect to the base A and the base B.

8. The hydroelectric power generator according to claim 6,
wherein the blade structure includes
a side wall a facing the base A,
a side wall b facing the base B, and
a side wall c1 orthogonal to the side wall a and the side wall b,
where the projection a is disposed on the side wall a, and the projection b is disposed on the side wall b.

9. The hydroelectric power generator according to claim 8,
wherein the side wall a of the blade structure has two or more holes a, and the side wall b of the blade structure has two or more holes b.

10. The hydroelectric power generator according to claim 9,
wherein the base A has a hole A corresponding to the hole a of the blade structure, and
the base B has a hole B corresponding to the hole b of the blade structure,
wherein one fixing member of the one or more fixing members passes through the hole A and the hole a, and another fixing member of the one or more fixing members passes through the hole B and the hole b to fix the rotatable blade structure.

11. The hydroelectric power generator according to claim 10,
wherein one fixing member of the one or more fixing members is arranged on an outer edge of the base A and another fixing member of the one or more fixing members is arranged on an outer edge of the base B.

12. The hydroelectric power generator according to claim 9,
wherein the blade structure includes an identification mark adjacent to each of the holes a and the holes b to identify a position of each hole among the two or more holes a and the two or more holes b.

13. The hydroelectric power generator according to claim 6,
wherein the hydroelectric power generator includes a plurality of the blade structures, where each of the blade structures includes an identifier to identify a variety of each of the blade structures.
